(19) United States
(12) Patent Application Publication
(10) Pub. No.: US 2023/0281605 A1
(43) Pub. Date: Sep. 7, 2023

(54) META-TRANSACTION-ENABLED RELAY PROTOCOLS FOR CONTENT TRANSFER AGGREGATION

(71) Applicant: Data Mynt, Inc., Oakland, CA (US)

(72) Inventors: Alexander J. Christian, Oakland, CA (US); Shivam Chaturvedi, Bangalore (IN); Vinod Morkile, Pune (IN)

(73) Assignee: Data Mynt, Inc., Oakland, CA (US)

(21) Appl. No.: 17/685,620

(22) Filed: Mar. 3, 2022

(51) Int. Cl. G06Q 20/36; G06Q 20/40; G06Q 20/38; G06Q 20/06

(52) U.S. Cl. CPC G06Q 20/3674; G06Q 20/401; G06Q 20/38215; G06Q 20/065; G06Q 2220/00

(57) ABSTRACT

Content transfer technologies are disclosed that relate to meta-transaction-enabling code implemented in a cryptographic wallet or other content destination. A meta-transaction arriving there can be parsed so that a sender identifier distinguished from one or more intermediaries that expedited the transfer. Conditions may be imposed by some transfer participants who do not all know each other without any need for escrow or trust among them so that arbitrarily complex transactions can occur safely at scale.

### BRIEF DESCRIPTION OF THE DRAWINGS

FIG. 1 schematically illustrates a system in which respective interfaces interact across the Pacific Ocean in which one or more improved technologies may be incorporated.

FIG. 2 schematically illustrates a system in which respective users or other entities interact with one another and with participating mining rigs or similar distributed devices in which one or more improved technologies may be incorporated.

FIG. 3 schematically illustrates a system in which one or more linkages operably couple one or more ledgers of a primary platform with one or more ledgers of a support platform in which one or more improved technologies may be incorporated.

FIG. 4 depicts a ledger interaction device in which one or more improved technologies may be incorporated.

FIG. 5 depicts a server in which one or more improved technologies may be incorporated.

FIG. 6 depicts code for use in a meta-transaction-enabling “permit” function in which one or more improved technologies may be incorporated.

FIG. 7 depicts additional code for use in a “permit” function like that of FIG. 6 in which one or more improved technologies may be incorporated.

FIG. 8 depicts code for use in an “executeMetaTransaction” function in which one or more improved technologies may be incorporated.

FIG. 9 depicts additional code for use in an “executeMetaTransaction” function like that of FIG. 8 in which one or more improved technologies may be incorporated.

FIG. 10 depicts code that allows a user to provide an off-chain signature for use in a meta-transaction in which one or more improved technologies may be incorporated.

FIG. 11 depicts code that allows a user's signature to serve as a parameter and a function signature both in a meta-transaction in which one or more improved technologies may be incorporated.

FIG. 12 depicts a data flow and event sequence in which one or more improved technologies may be incorporated.

### DETAILED DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote file servers, computer servers and memory storage devices.

It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Associated,” “at least,” “available,” “based on,” “caused,” “detected,” “execution-prerequisite,” “expended,” “in response,” “meta-transaction-enabling,” “non-zero,” “of,” “on-chain,” “only after,” “participant-defined,” “particular,” “performed by,” “permitted,” “pernicious,” “protected,” “remote,” “said,” “single,” “suitable,” “verified,” “via,” “when,” “wherein,” “within,” “without,” or other such descriptors herein are used in their normal yes-or-no sense, not merely as terms of degree, unless context dictates otherwise.

In light of the present disclosure those skilled in the art will understand from context what is meant by “remote” and by other such positional descriptors used herein. Likewise they will understand what is meant by “partly based” or other such descriptions of dependent computational variables/signals. “On-chain” refers to (permanent) inclusion in a blockchain, whether or not such content is public or transparent. “On-list” encompasses not only on-chain but also other content linked and effectively rendered immutable using cryptography (e.g., in a consensus-based data verification). In an implementation that includes “on-list” content (e.g., a blockchain or tangle) as described below, “off-list” refers to content elements (e.g., an in-app account ledger) that have yet to be included “on-list.” A “batch” data distribution (broadcast) is one in which data is directed to numerous recipients within a limited time (e.g., less than 24 hours) after a triggering event (e.g., an administrator action or weekly trigger time). “Numerous” as used herein refers to more than one dozen. Terms like “processor,” “device,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

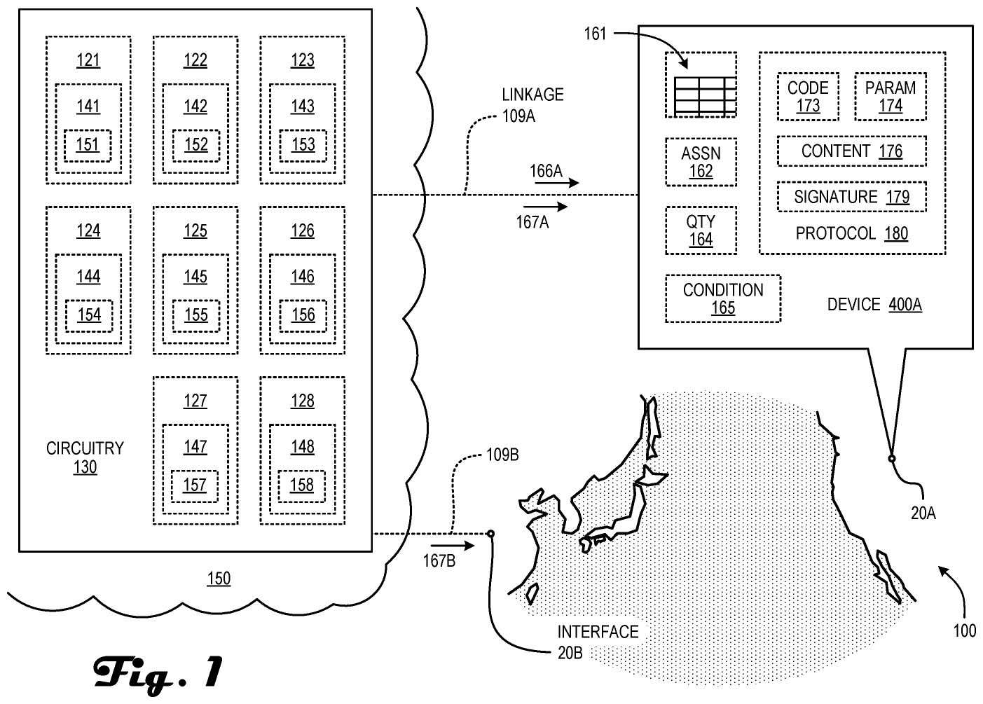

FIG. 1 schematically illustrates a system 100 in which interfaces 20A-B interact via computer network 150 and across the Pacific Ocean. Interface 20A, for example, may comprise a mobile device 400A facilitating a content transfer 166A via wireless linkages 109A-B that are immutably recorded. This may occur, for example, in a context in which one or more records 161 establish one or more associations 162 via which a quantity 164 of digital resources other content 176 is received or sent (or both) using one or more instances of local code 173, of operating parameters 174, or of signatures 179 provided by respective entities that participate. Alternatively or additionally, such transfers 166 may trigger appropriate notifications 167A-B explaining one or more instances of delivery quantities 164, of (corresponding services or other such) conditions 165, or other such transfer-descriptive metadata.

In various implementations special-purpose transistor-based circuitry 130—optionally implemented as an ASIC or in a UI governance server, for example—in which some or all of the functional modules described herein may be implemented. Such circuitry 130 includes one or more instances of invocation modules 121, for example, each including an electrical node set 141 upon which informational data is represented digitally as a corresponding voltage configuration 151. Such circuitry 130 likewise may include one or more instances of validation modules 122 each including an electrical node set 142 upon which informational data is represented digitally as a corresponding voltage configuration 152. Such circuitry 130 likewise may include one or more instances of response modules 123 each including an electrical node set 143 upon which informational data is represented digitally as a corresponding voltage configuration 153. Such circuitry 130 likewise may include one or more instances of prioritization modules 124 each including an electrical node set 144 upon which informational data is represented digitally as a corresponding voltage configuration 154. Such circuitry 130 likewise may include one or more instances of relay modules 125 each including an electrical node set 145 upon which informational data is represented digitally as a corresponding voltage configuration 155. Such circuitry 130 likewise may include one or more instances of recognition modules 126 each including an electrical node set 146 upon which informational data is represented digitally as a corresponding voltage configuration 156. Such circuitry 130 likewise may include one or more instances of transfer modules 127 each including an electrical node set 147 upon which informational data is represented digitally as a corresponding voltage configuration 157. Such circuitry 130 likewise may include one or more instances of registration modules 128 each including an electrical node set 148 upon which informational data is represented digitally as a corresponding voltage configuration 158. In some variants, as described below in the clauses and claims, such a module implements such functionality jointly (e.g., in conjunction with one or more invocation modules 121 or processors described herein). Alternatively or additionally, in some variants such modules (or components thereof) may be distributed (e.g., so that some are implemented in special-purpose circuitry of respective nodes or servers) as described above.

As used herein, a plain reference numeral (e.g., like 166) may refer generally to a member of a class of items (e.g., like transfers) exemplified with a hybrid numeral (e.g., like 166A) and it will be understood that every item identified with a hybrid numeral is also an exemplar of the class. Moreover although a reference numeral shared between figures refers to the same item, most figures depict respective embodiments.

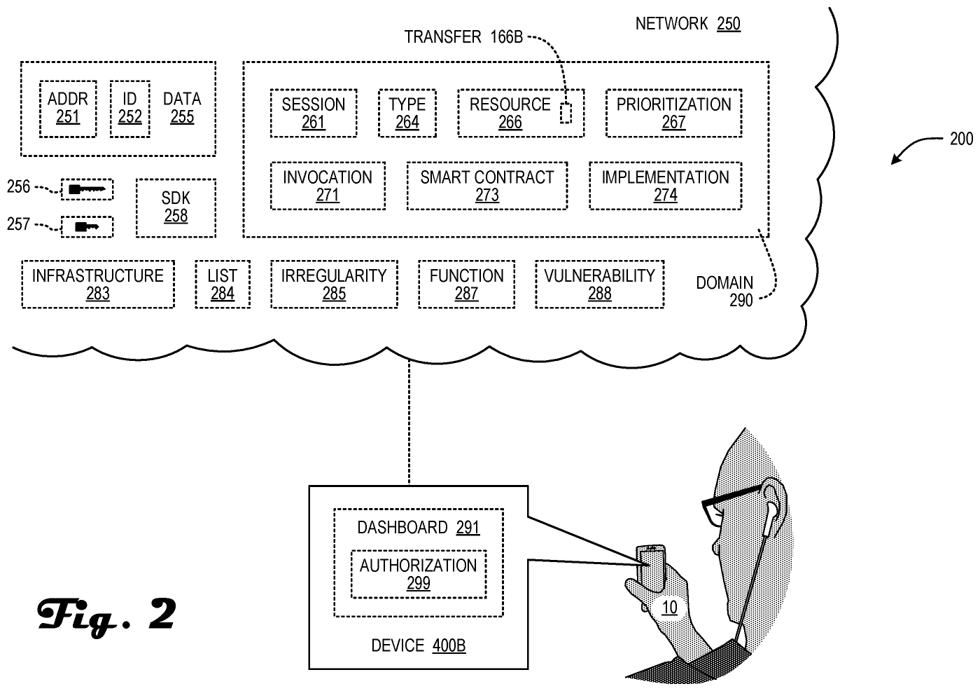

FIG. 2 schematically illustrates a system 200 that may instantiate or otherwise interact with the system 100 of FIG. 1, for example, by a linkage 109 (not shown) operably coupling network 150 with one or more instances of network 250. Each such instance may include one or more addresses 251, identifiers 252, or other functional data 255 protected by various digital keys 256, 257 with some assistance from a software development kit 258. Each user 10 or other registered entity receiving such transfers 166B has a digital domain 290 comprising one or more instances of sessions 261, of types 264, of resources 266, of (individual or collective) prioritizations 267, of invocations 271, of smart contracts 273, or of other implementations 274 as described herein. Moreover such networks 250 may deal in other components of infrastructure 283, of component lists 284, of risk-indicative irregularities, of automated functions 287 described herein, or of vulnerabilities 288 that may result and be monitored. In some contexts, moreover, such a domain 290 may likewise include a dashboard 291 or other software by which a user gives or obtains authorizations 299 to build and use meta-transactions as further described below.

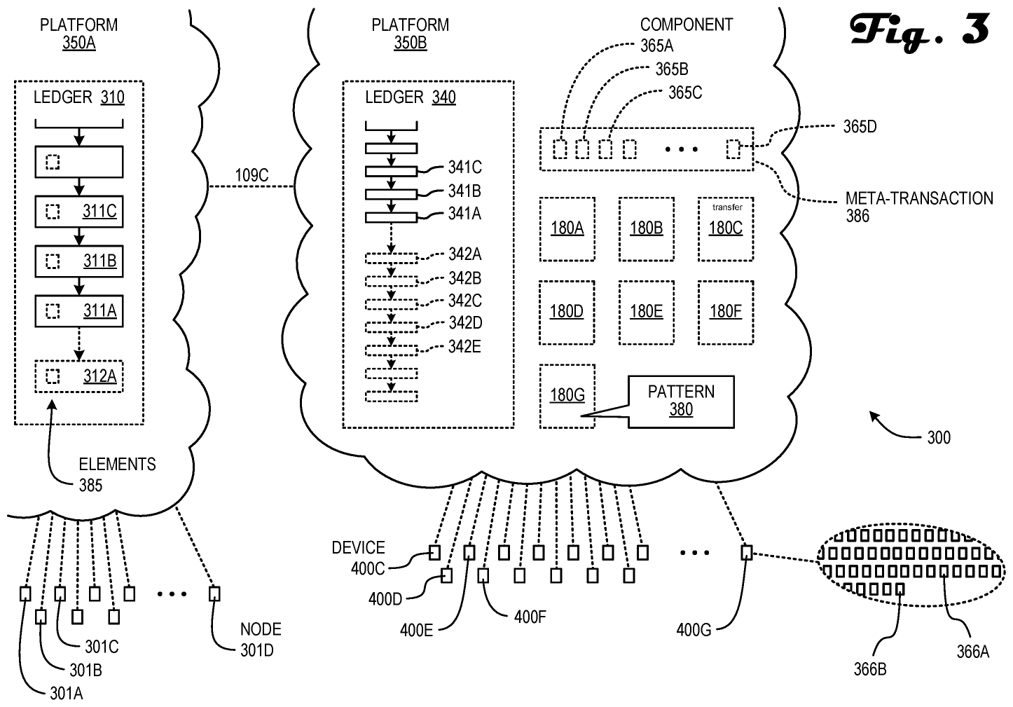

FIG. 3 schematically illustrates a system 100 that may instantiate or otherwise interact with the above-described systems 100, 200 in which a linkage 109C operably couples one or more ledgers 310 of a primary platform 350A (e.g., an ETH-type or BTC-type public blockchain) with one or more ledgers 340 of a support platform 350B (e.g., a Polygon-type or similar side chain). As shown ledger 310 includes a series of most recent blocks 311A, 311B, 311C protected (e.g., by one or more hash functions 287) from surreptitious alteration by one or more elements 385 (e.g., hash values) of each next block 312A and by a sufficient consensus among numerous nodes 301A-D (e.g., hundreds of mining rigs or the like). Likewise as shown ledger 340 includes a series of most recent blocks 341A, 341B, 341C is protected from surreptitious alteration and otherwise enriched by elements 385 of each next block 342A-E so as to allow numerous devices 400C-G to move digital resources 266 and other valuable content 176 in streamline data handling protocols 180A-G that make and use meta-transactions 386 that combine two or more components 365A-D as described herein. This can occur, for example, in a context in which an infrastructure 283 operably couples an Ethereum-connected blockchain platform 350A with various Polygon support platforms 350B and in which very numerous transactions 366A-B among such numerous participants would otherwise suffer denials of service or other such vulnerabilities 288. In some variants a delegated transfer protocol 180A allows an implementation 274 of meta-transactions 386 in which one or more components 365 thereof effectively provide frictionless delegated transfers 166 or other interactions 366 for numerous registered users 10 at high volume (i.e. exceeding 2 million transfers 166 per hour) in a vetted community.

As used herein a “meta-transaction” is a chain or cluster of two or more component transfers 166 among respective entities each comprising one or more device users 10. In some variants a meta-transaction 386 works on top of a public distributed ledger 310 (e.g., Ethereum's primary blockchain) and uses one or more side chains to prevent “clogging” the main platform 350A. In some variants each meta-transaction 385 is signed by a given key pair (e.g., a private key 256 and corresponding public key 257) but is triggered by a relay module 125 to use one or more blockchain-accessible networks 150, 250 that is hash protected on one or more public ledgers 310. Some such relay modules submit an already-signed (component) transfer 166 to one or more primary networks 150 as if they are the sender thereof through an efficient time-varying a priority-indicative scalar value (e.g., a gas fee). In some variants such aggregation can work because our parsing protocol 180B resides (e.g., as a smart contract 273 or other meta-transaction-enabling code 173) in each receiving registered user's domain 290 so as to extract from each meta-transaction 386 a sender identifier 252 in association 162 with a first transfer 166 of first content 176 from a corresponding sender. In some variants as described below, moreover, additional meta-transaction-enabling code 173 permits a meta-transaction 386 to be executed only after a pattern recognition protocol 180C is applied by which a favorable or unfavorable data pattern 380 is compared against one or more components 365 of a proposed meta-transaction 386.

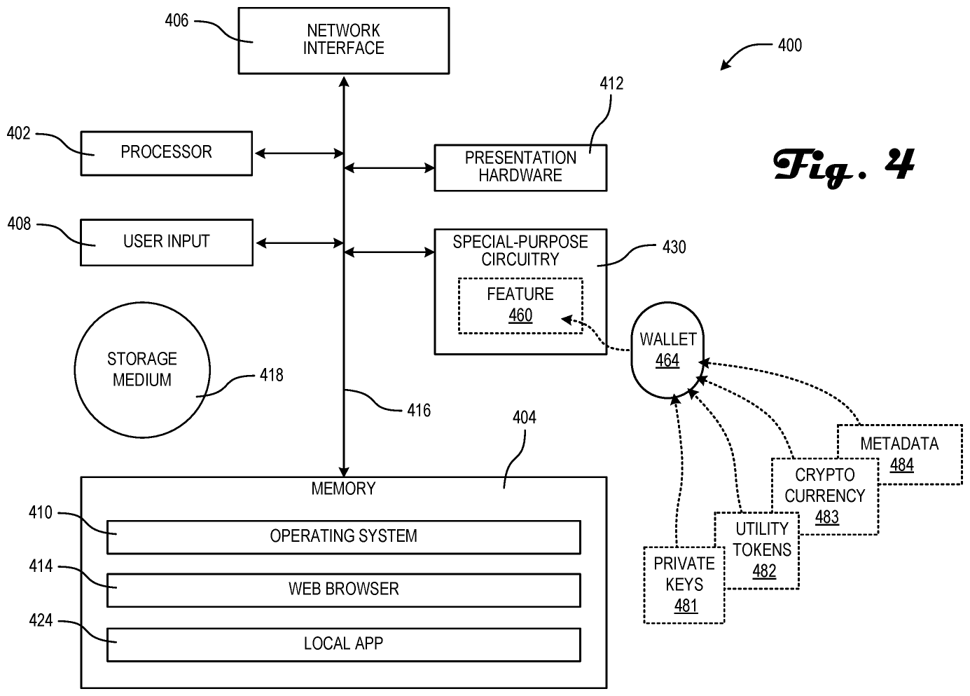

Referring now to FIG. 4, there is shown a ledger interaction device 400 like those of FIGS. 1-3. Device 400 may include one or more instances of processors 402, memory 404, user inputs 408, and presentation hardware 412 all interconnected along with the network interface 406 via a bus 416. One or more network interfaces 406 allow device 400 to connect via the Internet or other networks 150, 250 to or within platforms 350A-B of FIG. 3). Memory 404 generally comprises a random access memory (“RAM”), a read only memory (“ROM”), and a permanent mass storage device, such as a disk drive.

Memory 404 may contain one or more instances of operating systems 410, of web browsers 414 (e.g., featuring a secure local client of a mostly-remote dashboard 291), or of special-purpose local apps 424 (e.g., resident within a handheld mobile device 400B and operable to control distributed components of a personal domain 290 owned by a user 10 of the device 400B). These and other software components may be loaded from a non-transitory computer readable storage medium 418 into memory 404 of the client device 400 using a drive mechanism (not shown) associated with a non-transitory computer readable storage medium 418, such as a floppy disc, tape, DVD/CD-ROM drive, flash card, memory card, or the like. In some embodiments, software components may also be loaded via the network interface 406, rather than via a computer readable storage medium 418. Special-purpose circuitry 430 may, in some variants, include some or all of the event-sequencing logic described below (e.g., in a peer-to-peer implementation) and one or more security features 460. In some contexts such features 460 may include or interact with a digital wallet 464 comprising one or more instances of private keys 481, of utility tokens 482, of crypto currency 483, or of metadata 484. Alternatively or additionally such features 460 may include ASICs, GPU's, or other special-purpose components by which a given device 400 may serve as blockchain or other ledger node 301 as described above. In some embodiments client device 400 may include many more components than those shown in FIG. 4, but it is not necessary that all conventional components be shown in order to disclose an illustrative embodiment.

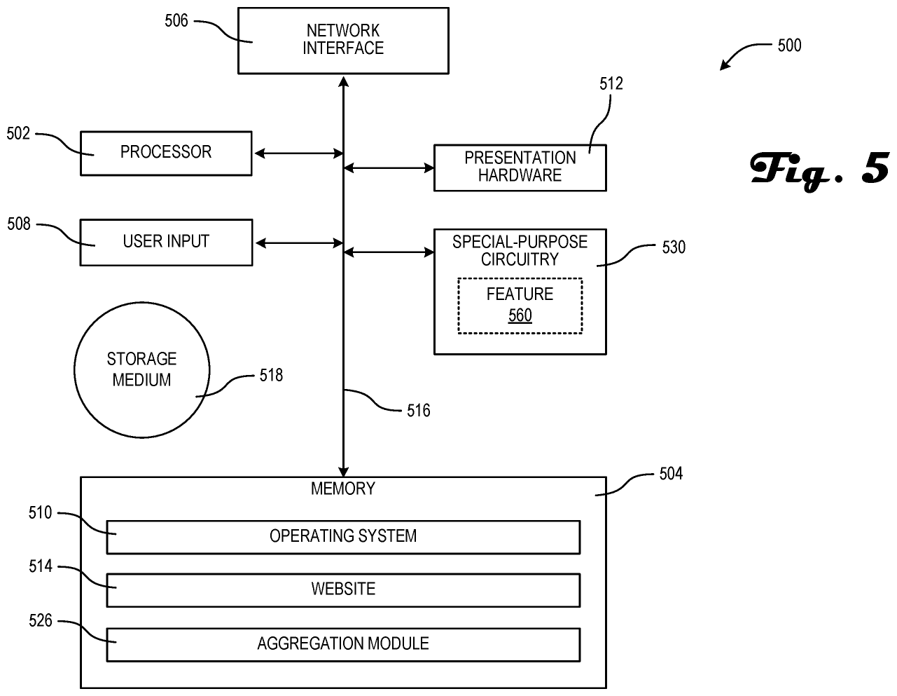

Referring now to FIG. 5, there is shown an exemplary server 500 of one or more networks 150, 250 described herein. Server 500 may include one or more instances of processors 502, memory 504, user inputs 508, and presentation hardware 512 all interconnected along with the network interface 506 via a bus 516. One or more network interfaces 506 allow server 500 to connect via the Internet or other networks to or within entities 210 of FIG. 2). Memory 504 generally comprises a random access memory (“RAM”), a read only memory (“ROM”), and a permanent mass storage device, such as a disk drive.

Memory 504 may contain one or more instances of operating systems 510, hosted websites 514, and aggregation modules 526. These and other software components may be loaded from a non-transitory computer readable storage medium 518 into memory 504 of the server 500 using a drive mechanism (not shown) associated with a non-transitory computer readable storage medium 518, such as a floppy disc, tape, DVD/CD-ROM drive, flash card, memory card, or the like. In some embodiments, software components may also be loaded via the network interface 506, rather than via a computer readable storage medium 518. Special-purpose circuitry 530 may, in some variants, include some or all of the event-sequencing logic described below (e.g., in a peer-to-peer implementation) and one or more security features 560 (e.g., a firewall). In some embodiments server 500 may include many more components than those shown in FIG. 5, but it is not necessary that all conventional components be shown in order to disclose an illustrative embodiment.

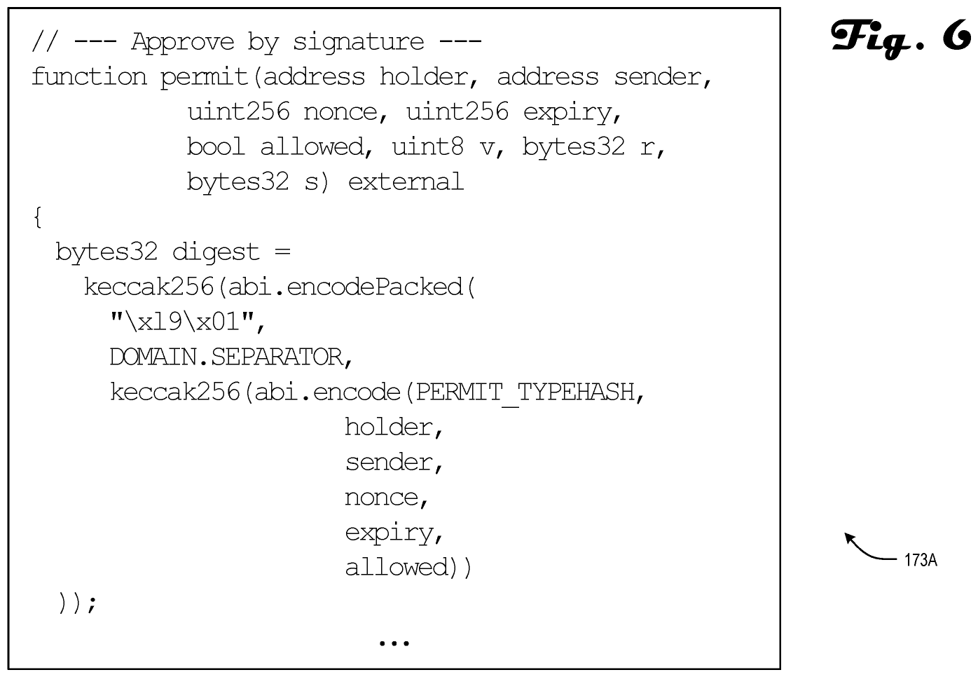

FIG. 6 depicts code 173A for use in a “permit” function 287 in smart contracts 273 that allow meta-transactions 386 to be made and used as described herein. This can occur, for example, in a context in which the “sender” to which the code 173A refers corresponds to a device 400B-G herein prepared to send content 176, to a user 10 of that device, or to a private key 256 provided by that user 10 pursuant to an upcoming transfer 166 via such a meta-transaction 386.

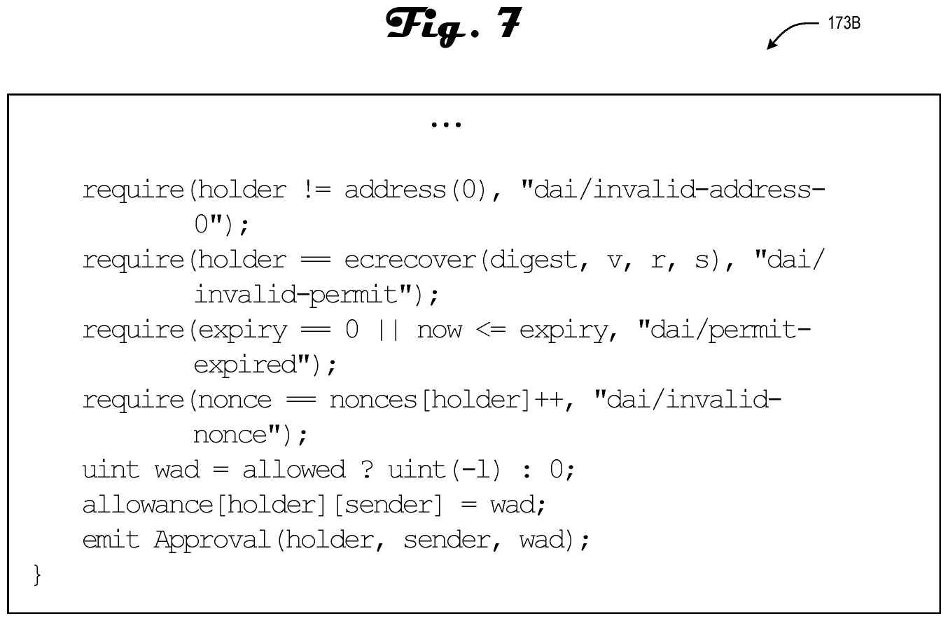

FIG. 7 depicts additional code 173B for use in a “permit” function 287 like that of FIG. 6 in which one or more improved technologies may be incorporated. This can occur, for example, in a context in which at least some of the content 176 to be transferred via meta-transactions 386 comprises one or more instances or types 264 of private keys 481, of utility tokens 482, of cryptocurrencies 483, or of metadata 484 describing off-chain events (e.g., completed tasks) or other services.

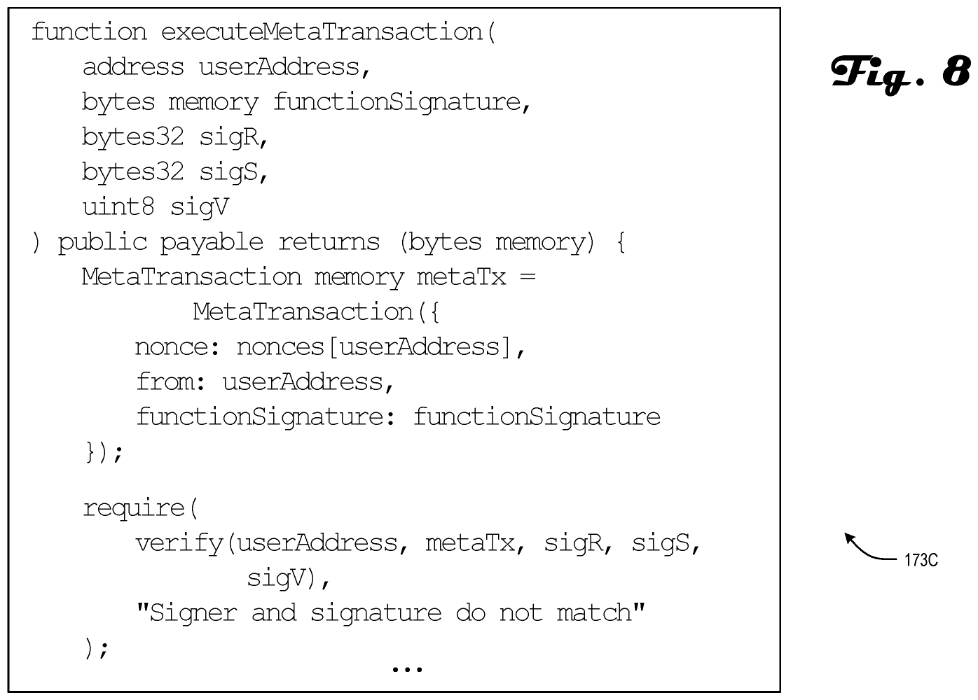

FIG. 8 depicts code 173C for use in an “executeMetaTransaction” function 287 that transfers tokens or other resources 266 in which one or more improved technologies may be incorporated.

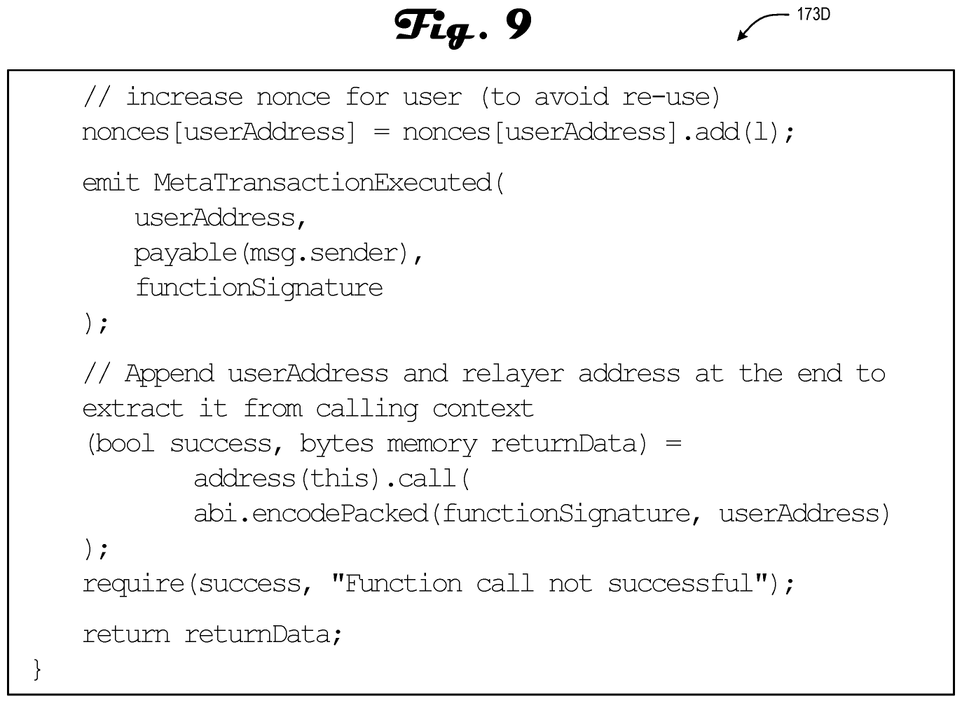

FIG. 9 depicts additional code 173D for use in an “executeMetaTransaction” function 287 like that of FIG. 8 in which one or more improved technologies may be incorporated. This can occur, for example, in a context in which addresses 251 of a “sender” and of a relay module 125 are extracted during (an invocation 271 of) the “executeMetaTransaction” function 287.

In some variants each valid meta-transaction 386 follows one or more formatting protocols 180D for encoding one or more operating parameters 174, content 176, and a signature 179 from each original sender in a way that such components 365 can be extracted at each destination domain 290 (e.g., by a “target” smart contract 273 therein) regardless of the “msg.sender.” But in some off-chain service protocols 180E there is an Application Programming Interface (API) invocation protocol 180F or other messaging protocol 180G that links each original sender to a corresponding (instance of a) relay module 125 such that each participating relay module 125 has a suitable infrastructure 283 and resources 266 (e.g., Ethereum gas) to bundle that transfer 166 with content 176 from other sources and forward a resulting meta-transaction 386 to parsing code 173 resident at a domain 290 controlled by a meta-transaction-enabled receiving device 400A.

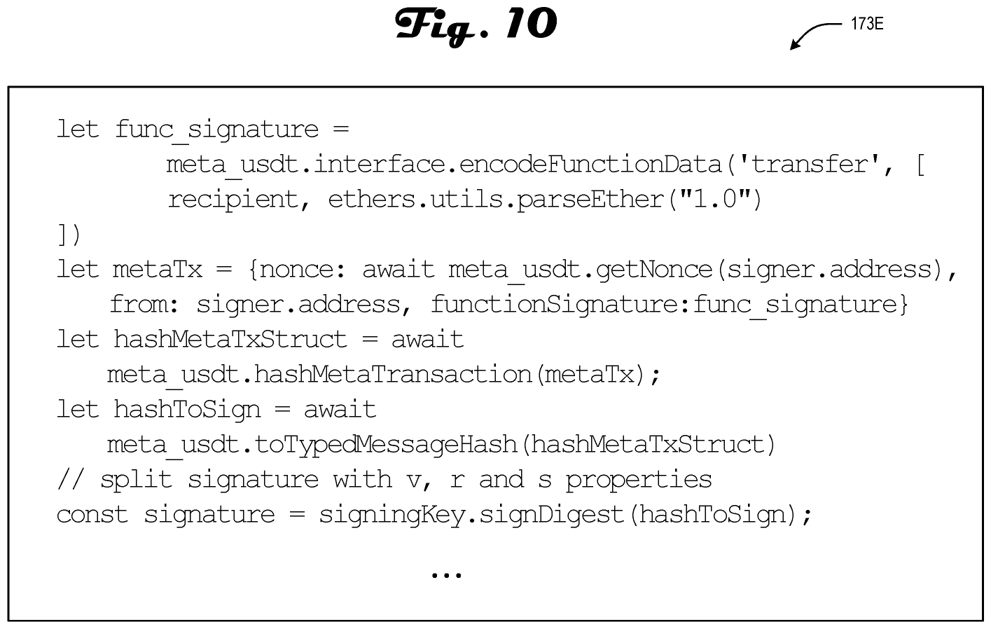

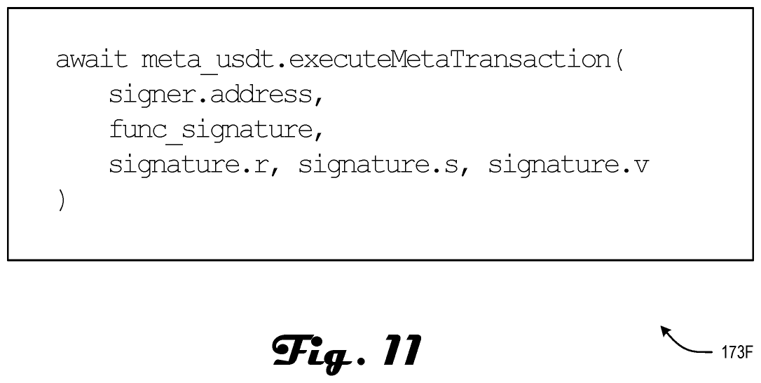

FIG. 10 depicts code 173E that allows a user to provide an off-chain signature for use in a meta-transaction in which one or more improved technologies may be incorporated. This can occur, for example, in a context in which “first” meta-transaction-enabling code 173 is implemented in a “first” receiving domain 290 associated with a “first” user 10 of a “first” interface 20A that includes a “first” cryptographically secured digital wallet 464; in which the meta-transaction-enabling code 173 comprises one or more meta-transaction-enabling smart contracts 273 like those of FIGS. 6-10; in which such code 173 extracts from a “first” meta-transaction 386 a (sender address 251 or other) sender identifier 252 in association 162 with a transfer 166 of “first” content 176 from a remote interface 20B of a (sending) “second” user 10; in which a delivery and parsing of the “first” meta-transaction 386 at the “first” receiving domain 290 was expedited by one or more relay modules 125 having expended a first (non-zero amount of a) digital resource 266; and in which such delivery, parsing, and completed end-to-end transfer 166 would otherwise be prevented by a denial of service attack or other such vulnerability. In some segmented transfer protocols 180A, for example, the sending “second” user 10 initially provides an authorization 299 for such a transfer 166 off-chain, without the transfer 166 being broadcast to a Layer-2 ledger 340 (e.g., a Polygon blockchain platform 350B) until the “first” meta-transaction-execution function 287 is called (e.g., by a transfer module 127) using an earlier-provided signature 179 from the sending “second” user 10. See FIG. 11.

FIG. 11 depicts code 173F that allows a user's signature to serve as a parameter 174 and a function signature 179 both in a meta-transaction 386 in which one or more improved technologies may be incorporated. In a smart contract 273 that includes such code 173F, for example, a relay module 125 may be implemented such that a sending user's address 251 is extracted from the meta-transaction 386 during an execution thereof on a Layer-2 platform 350B from any suitable relay module wallet 464 (e.g., expedited with a non-zero quantity of Polygon Matic or similar utility tokens 482 on a “side chain” or similar ledger 340).

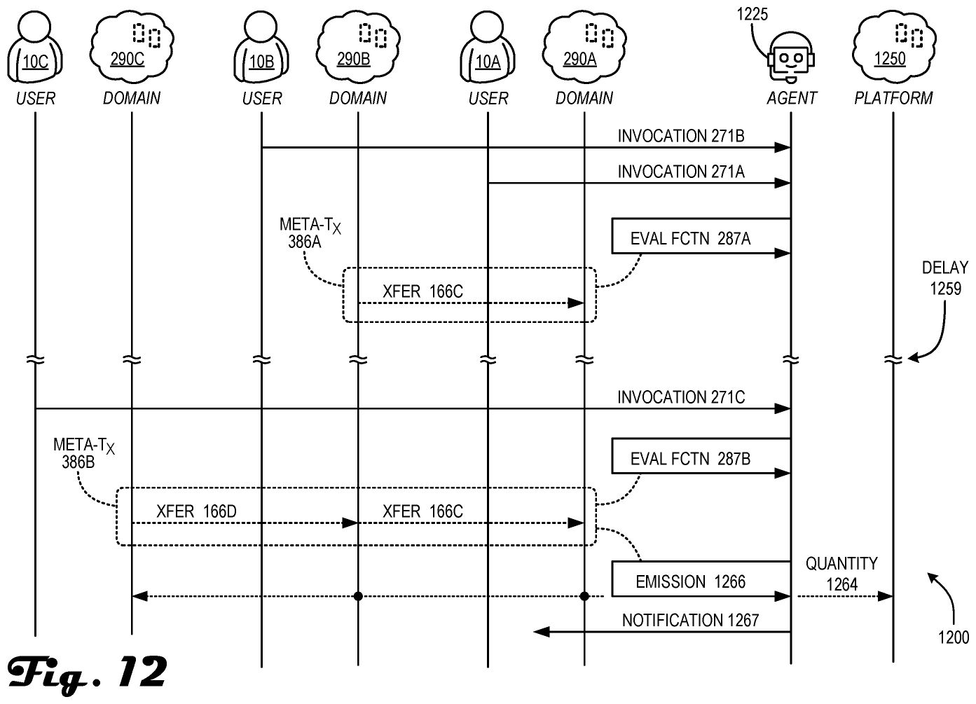

FIG. 12 depicts a data flow 1200 in which several users 10A-C each having respective domains 290A-C work through an agent 1225 (comprising one or more special-purpose modules 121-128 or other suitable circuitry 130) to establish, validate, and implement a meta-transaction 386 of arbitrary complexity to a distributed ledger 310, 340 or similar platform 350, 1250. First and second users 10A-B transmit respective invocations 271A-B that specify one or more associations 162, quantities 164, conditions 165, or other components of protocols 180 described herein (or a combination thereof) so as to establish an inchoate meta-transaction 386A that one or more evaluation functions 287 can check for validity. In a context in which the inchoate meta-transaction 386A thereby established fails to meet one or more requirements (e.g., by meeting or not meeting a condition 165 provided by one of the participating users 10B that a transfer 166C to a specific domain 290B of qualifying content 176 occur), the inchoate meta-transaction 386A is not implemented. The inchoate meta-transaction 386A remains established for a limited delay 1259 (e.g., for a maximum threshold of a few hours or a few days as set by one of the participating users 10A-B) and, after a third participating user 10C also transmits an invocation 271C to the agent 1225 specifying one or more additional conditions 165 or other meta-transaction elements 365 so as to establish an improved prospective meta-transaction 386B that an evaluation function 287B can check for validity. If the meta-transaction 386B is now complete by virtue of one or more last conditions 165 being satisfied (e.g., by the addition of a transfer 166D from domain 290C to domain 290B), the evaluation function 287B will indicate that meta-transaction 386B is valid and ready to be implemented. The resulting emission 1266 provides at least an end-to-end content transfer 166C between domains 290A-B and another end-to-end content transfer 166D between domains 290B-C as shown, as well as a non-zero quantity 1264 of a suitable token type 264 (e.g., Ethereum gas or) to expedite the finalized meta-transaction 386.

In light of teachings herein, numerous existing techniques may be applied for configuring special-purpose circuitry or other structures effective for configuring, aggregating, and otherwise managing content transfers 166 and other operations as described herein without undue experimentation. See, e.g., U.S. Pat. No. 11,210,383 (“Content authentication and validation via multi-factor digital tokens, systems, and methods”); U.S. Pat. No. 11,139,081 (“Blockchain gene system”); U.S. Pat. No. 10,949,557 (“Blockchain-based auditing, instantiation and maintenance of 5G network slices”); U.S. Pat. No. 9,747,586 (“System and method for issuance of electronic currency substantiated by a reserve of assets”); U.S. Pat. No. 9,672,499 (“Data analytic and security mechanism for implementing a hot wallet service”); U.S. Pat. No. 9,646,029 (“Methods and apparatus for a distributed database within a network”); U.S. Pat. No. 9,569,771 (“Method and system for storage and retrieval of blockchain blocks using Galois fields”); U.S. Pat. No. 9,569,439 (“Context-sensitive query enrichment”); U.S. Pub. No. 20180183606 (“Verifying Authenticity of Computer Readable Information Using the Blockchain; U.S. Pub. No. 20180129955 (“Hybrid Blockchain Data Architecture for use Within a Cognitive Environment; U.S. Pub. No. 20170364698 (“Fragmenting data for the purposes of persistent storage across multiple immutable data structures; U.S. Pub. No. 20170116693 (“Systems and Methods for Decentralizing Commerce and Rights Management for Digital Assets Using a Blockchain Rights Ledger”); and U.S. Pub. No. 20160260095 (“Containerized Computational Task Execution Management Using a Secure Distributed Transaction Ledger”).

In particular, numerous existing techniques may be applied for configuring special-purpose circuitry or other structures effective for updating security-related criteria 163, evaluating authorizations 299 or other conditions 165, or other such functions 287 as described herein without undue experimentation. See, e.g., U.S. Pat. No. 11,171,950 (“Secure cloud-based storage system management”); U.S. patent Ser. No. 11/042,147 (“Machine-to-machine transactions using distributed ledgers in process control systems”); U.S. Pat. No. 10,121,025 (“Content validation using blockchain”); U.S. Pat. No. 10,068,397 (“System and method for access control using context-based proof”); U.S. Pat. No. 10,063,568 (“User behavior profile in a blockchain”); U.S. patent Ser. No. 10/050,959 (“Synthetic genomic variant-based secure transaction devices, systems and methods”); U.S. Pub. No. 20180332070 (“User Behavior Profile Environment”); U.S. Pub. No. 20180157825 (“Systems and Methods for Determining Trust Levels for Computing Components Using Blockchain”); and U.S. Pub. No. 20180097841 (“System and method for omnichannel social engineering attack avoidance”).

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

In the numbered clauses below, specific combinations of aspects and embodiments are articulated in a shorthand form such that (1) according to respective embodiments, for each instance in which a “component” or other such identifiers appear to be introduced (e.g., with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### Clauses

1. A meta-transaction-enabling content transfer method comprising:
invoking first transistor-based circuitry (e.g., one or more registration modules 128) configured to implement first (instance of) meta-transaction-enabling code 173 in a domain 290A (of or otherwise) associated with the first entity associated with a first entity wherein the first meta-transaction-enabling code 173 comprises one or more meta-transaction-enabling smart contracts 273;
invoking second transistor-based circuitry (e.g., one or more response modules 123) configured to cause the first meta-transaction-enabling code 173 in the domain 290A associated with the first entity to extract from a first meta-transaction 386 a (sender address 251 or other) sender identifier 252 in association 162 with a first transfer 166 of first content 176 from a second entity after the first meta-transaction 386 was sent to the domain 290A associated with the first entity by the one or more relay modules 125 wherein the first transfer 166 of the first content 176 from the second entity is a first component 365 of the first meta-transaction 386 and wherein the transfer 166 of the first meta-transaction 386 to the domain 290A associated with the first entity is expedited by the one or more relay modules 125 expending a first (non-zero amount of a) digital resource 266; and
invoking third transistor-based circuitry (e.g., one or more relay modules 125) configured to cause the first content 176 to become available to the first entity (within or otherwise) via the domain 290A associated with the first entity partly based on the sender identifier 252 associated with the first transfer 166 of the first content 176 having been extracted from (a digital expression of) the first meta-transaction 386 and partly based on a first cryptographic key 256 at least some of which was received (directly or otherwise) from the second entity.
2. The method of ANY one of the above method clauses comprising:
invoking fourth transistor-based circuitry (e.g., one or more instances of a transfer module 127) configured to cause an emission 1266 that implements the first meta-transaction 386 to a Layer-2 support platform 350B as described herein partly based on no irregularities 285 having been detected by the evaluation function(s) 287 and partly based on a prioritization 267 by which a non-zero quantity 164 of utility tokens 482 are expended.
3. The method of ANY one of the above method clauses comprising:
invoking fourth transistor-based circuitry (e.g., one or more instances of a transfer module 127) configured to cause an emission 1266 as described herein that implements the first meta-transaction 386 to a (Polygon-type or other) support platform 350B partly based on no irregularities 285 having been detected by the evaluation function(s) 287 and partly based on a prioritization 267 by which a non-zero quantity 164 of (Matic-type or other) utility tokens 482 are expended.
4. The method of ANY one of the above method clauses comprising:
invoking other transistor-based circuitry (e.g., one or more instances of a transfer module 127) configured as described herein to cause an emission 1266 that implements the first meta-transaction 386 to a first (Ethereum-type or other) public blockchain platform 350A partly based on no irregularities 285 having been detected by the evaluation function(s) 287 and partly based on a prioritization 267 by which a non-zero (Ethereum-type or other) cryptocurrency quantity 164 is expended.
5. The method of ANY one of the above method clauses comprising:
invoking fourth transistor-based circuitry (e.g., one or more instances of a transfer module 127) configured to cause an emission 1266 that implements the first meta-transaction 386 wherein second meta-transaction-enabling code 173 (is included or otherwise accessible and) permits the first meta-transaction 386 to be executed only after (at least an instance of) a pattern recognition protocol 180C is applied by which a first meta-transaction-execution-prerequisite condition 165 is verified and wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to (a domain 290B of) the second entity.
6. The method of ANY one of the above method clauses comprising:
invoking fourth transistor-based circuitry (e.g., one or more instances of a transfer module 127) configured to cause an emission 1266 that implements the first meta-transaction 386 wherein second meta-transaction-enabling code 173 (is included or otherwise accessible and) permits the first meta-transaction 386 to be executed only after a pattern recognition protocol 180C is applied by which a first meta-transaction-execution-prerequisite condition 165 is verified;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity; and
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity.
7. The method of ANY one of the above method clauses comprising:
invoking fourth transistor-based circuitry (e.g., one or more instances of a transfer module 127) configured to cause an emission 1266 that implements the first meta-transaction 386 wherein second meta-transaction-enabling code 173 (is included or otherwise accessible and) permits the first meta-transaction 386 to be executed only after one or more pattern recognition protocols 180C are applied by which a first meta-transaction-execution-prerequisite condition 165 is verified;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity; and
wherein the third meta-transaction-execution-prerequisite condition 165 was received from the third entity.
8. The method of ANY one of the above method clauses comprising:
invoking fourth transistor-based circuitry (e.g., one or more instances of a transfer module 127) configured to cause an emission 1266 that implements the first meta-transaction 386 wherein second meta-transaction-enabling code 173 (is included or otherwise accessible and) permits the first meta-transaction 386 to be executed only after a pattern recognition protocol 180C is applied by which a first meta-transaction-execution-prerequisite condition 165 is verified;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity;
wherein the third meta-transaction-execution-prerequisite condition 165 was received from the third entity; and
wherein the first meta-transaction 386 provides that the particular second content type 264 is revealed to the first entity when and not before the first meta-transaction 386 is executed.
9. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 (e.g., specified or otherwise approved by a recipient thereof) to the domain 290A of the first entity and wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity.
10. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 to the domain 290A of the first entity;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity; and
wherein the second meta-transaction-execution-prerequisite condition 165 was received from the second entity.
11. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 to the domain 290A of the first entity;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein the second meta-transaction-execution-prerequisite condition 165 was received from the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity; and
wherein the third meta-transaction-execution-prerequisite condition 165 was received from the third entity.
12. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 to the domain 290A of the first entity;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein the second meta-transaction-execution-prerequisite condition 165 was received from the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity;
wherein the third meta-transaction-execution-prerequisite condition 165 was received from the third entity; and
wherein fifth meta-transaction-enabling code 173 permits the first meta-transaction 386 to be executed only after a fourth meta-transaction-execution-prerequisite condition 165 is verified that includes a fourth evaluation function 287 confirming that the first meta-transaction 386 includes a transfer 166 of a particular fourth content type 264 to a domain 290 of the fourth entity.
13. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 to the domain 290A of the first entity;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein the second meta-transaction-execution-prerequisite condition 165 was received from the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity;
wherein the third meta-transaction-execution-prerequisite condition 165 was received from the third entity;
wherein fifth meta-transaction-enabling code 173 permits the first meta-transaction 386 to be executed only after a fourth meta-transaction-execution-prerequisite condition 165 is verified that includes a fourth evaluation function 287 confirming that the first meta-transaction 386 includes a transfer 166 of a particular fourth content type 264 to a domain 290 of the fourth entity; and
wherein the fourth meta-transaction-execution-prerequisite condition 165 was received from the fourth entity.
14. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 to the domain 290A of the first entity;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein the second meta-transaction-execution-prerequisite condition 165 was received from the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity;
wherein the third meta-transaction-execution-prerequisite condition 165 was received from the third entity;
wherein fifth meta-transaction-enabling code 173 permits the first meta-transaction 386 to be executed only after a fourth meta-transaction-execution-prerequisite condition 165 is verified that includes a fourth evaluation function 287 confirming that the first meta-transaction 386 includes a transfer 166 of a particular fourth content type 264 to a domain 290 of the fourth entity;
wherein the fourth meta-transaction-execution-prerequisite condition 165 was received from the fourth entity; and
wherein the first meta-transaction 386 provides that the transfer 166 of the particular fourth content type 264 to the domain 290C of the fourth entity is to be sent from the domain 290A of the first entity.
15. The method of ANY one of the above method clauses comprising:
invoking fourth transistor-based circuitry (e.g., one or more instances of a transfer module 127) configured to cause an emission 1266 that implements the first meta-transaction 386 as described herein wherein second meta-transaction-enabling code 173 (is included or otherwise accessible and selectively) permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular first content type 264 to the domain 290A of the first entity;
wherein third meta-transaction-enabling code 173 permits the first meta-transaction 386 to be executed only after a second meta-transaction-execution-prerequisite condition 165 is verified that includes a second evaluation function 287 confirming that the first meta-transaction 386 includes a transfer 166D of a particular second content type 264 to a domain 290B of the second entity;
wherein the second meta-transaction-execution-prerequisite condition 165 was received from the second entity;
wherein fourth meta-transaction-enabling code 173 permits the first meta-transaction 386 to be executed only after a third meta-transaction-execution-prerequisite condition 165 is verified that includes a third evaluation function 287 confirming that the first meta-transaction 386 includes a transfer 166 of a particular third content type 264 to a domain 290C of the third entity;
wherein the third meta-transaction-execution-prerequisite condition 165 was received from the third entity;
wherein fifth meta-transaction-enabling code 173 permits the first meta-transaction 386 to be executed only after a fourth meta-transaction-execution-prerequisite condition 165 is verified that includes a fourth evaluation function 287 confirming that the first meta-transaction 386 includes a transfer 166 of a particular fourth content type 264 to a domain 290 of the fourth entity;
wherein the fourth meta-transaction-execution-prerequisite condition 165 was received from the fourth entity;
wherein the first meta-transaction 386 provides that the transfer 166 of the particular fourth content type 264 to the domain 290C of the fourth entity is to be sent from the domain 290A of the first entity; and
wherein the first meta-transaction 386 provides that at least an identifier 252 of the third entity is revealed to the first entity when and not before the first meta-transaction 386 is executed.
16. The method of ANY one of the above method clauses wherein (at least one instance of) all of the invoking all of the transistor-based circuitry was (directly or otherwise) performed by the first entity on a single mobile device 400.
17. The method of ANY one of the above method clauses wherein each of the meta-transaction-execution-prerequisite conditions 165 is verified by one or more (instances of) evaluation functions 287.
18. The method of ANY one of the above method clauses wherein each of the meta-transaction-execution-prerequisite conditions 165 is verified by one or more (instances of) evaluation functions 287 performed by one or more (instances of) validation modules 122.
19. The method of ANY one of the above method clauses wherein the first meta-transaction-execution-prerequisite condition 165 was approved before the invocations by the first and second entities both (at least).
20. The method of ANY one of the above method clauses wherein the first meta-transaction-execution-prerequisite condition 165 was a participant-approved meta-transaction-execution-prerequisite condition 165 approved by the first entity as a participant in the first meta-transaction 386.
21. The method of ANY one of the above method clauses wherein the first meta-transaction-execution-prerequisite condition 165 was a participant-selected meta-transaction-execution-prerequisite condition 165 selected by the first entity as a participant in the first meta-transaction 386.
22. The method of ANY one of the above method clauses wherein the first meta-transaction-execution-prerequisite condition 165 was a participant-defined meta-transaction-execution-prerequisite condition 165 defined by the first entity as a participant in the first meta-transaction 386.
23. The method of ANY one of the above method clauses wherein the first meta-transaction-execution-prerequisite condition 165 was received from the first entity.
24. The method of ANY one of the above method clauses wherein the first meta-transaction-execution-prerequisite condition 165 was received from the first entity.
25. The method of ANY one of the above method clauses wherein the first meta-transaction-execution-prerequisite condition 165 was received from a dashboard 291 used by the first entity.
26. The method of ANY one of the above method clauses wherein (at least one instance of) all of the invoking all of the transistor-based circuitry was performed by a dashboard 291 in response to user input 408 (e.g., from one or more human users 10 thereof).
27. The method of ANY one of the above method clauses wherein (at least one instance of) all of the invoking all of the transistor-based circuitry was performed by the first entity on a single mobile device 400A-B.
28. The method of ANY one of the above method clauses wherein (at least one instance of) all of the invoking all of the transistor-based circuitry was performed both by the first entity and by the second entity.
29. The method of ANY one of the above method clauses wherein (at least one instance of) all of the invoking all of the transistor-based circuitry was (directly or otherwise) performed by the first entity having provided an invocation 271 that enabled the first transfer 166 via a first dashboard 291 on a single mobile device 400A-B.
comprising: receiving some or all of the first cryptographic key 256 (directly or otherwise) from a domain 290 controlled by the second entity.
30. The method of ANY one of the above method clauses wherein (an instance of) some of the second meta-transaction-enabling code 173 (as described herein is included or otherwise accessible and) resides in a software development kit 258.
31. The method of ANY one of the above method clauses wherein a pattern recognition protocol 180C is applied as a component of second meta-transaction-enabling code 173 as described herein.
32. The method of ANY one of the above method clauses wherein second meta-transaction-enabling code 173 only allows the first meta-transaction 386 to be executed in response to a pattern recognition protocol 180C having been applied by which a first meta-transaction-execution-prerequisite condition 165 as described herein is verified.
33. The method of ANY one of the above method clauses wherein (one or more instances of) second meta-transaction-enabling code 173 permits the first meta-transaction 386 to be executed only after a pattern recognition protocol 180C is applied by which a first meta-transaction-execution-prerequisite condition 165 is verified as a conditional outcome of a pattern 380 indicative of irregularity 285 being recognized.
34. The method of ANY one of the above method clauses wherein (one or more instances of) second meta-transaction-enabling code 173 permits the first meta-transaction 386 to be executed only after (an instance of) a pattern recognition protocol 180C is applied by which a first meta-transaction-execution-prerequisite condition 165 is verified as a (negatively) conditional outcome of a pattern 380 indicative of a pernicious code vulnerability 288 being recognized.
35. The method of ANY one of the above method clauses wherein (one or more instances of) second meta-transaction-enabling code 173 permits the first meta-transaction 386 to be executed only after a pattern recognition protocol 180C is applied by which a first meta-transaction-execution-prerequisite condition 165 is verified as a conditional outcome of a suitable pattern 380 being recognized.
36. The method of ANY one of the above method clauses wherein one or more instances of second meta-transaction-enabling code 173 permit the first meta-transaction 386 to be executed only after a pattern recognition protocol 180C is applied by which a first meta-transaction-execution-prerequisite condition 165 is verified that includes a first evaluation function 287 confirming that the first meta-transaction 386 includes a transfer 166C of a first content type 264 to the domain 290A of the first entity, wherein a first content type 264 (as described herein is included and) comprises provenance-indicative metadata 484.
37. The method of ANY one of the above method clauses wherein a first evaluation function 287 (as described herein is included and) confirms that the first meta-transaction 386 includes a particular transfer 166C of a first content type 264 to the domain 290A of the first entity.
38. The method of ANY one of the above method clauses wherein second meta-transaction-enabling code 173 permits the first meta-transaction 386 to be executed only after a pattern recognition protocol 180C is applied by which a first participant-provided condition 165 is verified.
39. The method of ANY one of the above method clauses wherein second meta-transaction-enabling code 173 permits the first meta-transaction 386 to be executed only after a pattern recognition protocol 180C is applied by which a first participant-defined meta-transaction-execution-prerequisite condition 165 is verified.
40. The method of ANY one of the above method clauses wherein (an instance of) second meta-transaction-enabling code 173 outside the domain 290A (owned by or otherwise) associated with the first entity permits the first meta-transaction 386 to be executed.
41. The method of ANY one of the above method clauses wherein second meta-transaction-enabling code 173 permits the first meta-transaction 386 to be executed only after a pattern recognition protocol 180C is applied by which a first meta-transaction-execution-prerequisite condition 165 is verified that includes a first evaluation function 287 confirming that the first meta-transaction 386 indicates a transfer 166C of a particular non-zero quantity 164 of a first (type 264 of utility token 482 or other) content type 264 to the domain 290A of the first entity.
42. The method of ANY one of the above method clauses wherein at least a digital domain 290A of the first entity previously received the first cryptographic key 256 off-chain from the second entity.
43. The method of ANY one of the above method clauses wherein at least some of the first cryptographic key 256 was previously received off-chain.
44. The method of ANY one of the above method clauses wherein a first permit function 287 received at least some of the first cryptographic key 256 from (a digital domain 290B of) the second entity.
45. The method of ANY one of the above method clauses wherein a first permit function 287 received (an instance of) the first cryptographic key 256 from the second entity.
46. The method of ANY one of the above method clauses wherein the first entity comprises a first device 400A or a user 10A thereof (or both).
47. The method of ANY one of the above method clauses wherein the first entity comprises a first user 10A.
48. The method of ANY one of the above method clauses wherein the first entity comprises a first device 400A in use by a first user 10A.
49. The method of ANY one of the above method clauses wherein the first entity comprises a first (digital wallet 464 or other component) domain 290A associated with a first user 10A.
50. The method of ANY one of the above method clauses wherein the first entity comprises a first a cryptographically secured handheld digital wallet 464 owned by a first user 10A.
51. The method of ANY one of the above method clauses wherein (at least one instance of) all of the invoking all of the transistor-based circuitry was (directly or otherwise) performed by the second entity on a single mobile device 400A-G.
52. The method of ANY one of the above method clauses wherein the second entity has signed a first component 365 of a first-type token contract 273 so as to authorize a permit function 287 or the like (See FIGS. 6-7) whereby a second-type smart contract 273 obtains a conditional authorization 299 to collect the first content 176 to be transferred from a digital wallet 464 that belongs to the second entity on behalf of the first entity.
53. The method of ANY one of the above method clauses wherein first and second entities each authorize a meta-transaction-enabled transfer processing function 287 in a transfer-execution-type smart contract 273 to be used in executing the first meta-transaction 386.
54. The method of ANY one of the above method clauses wherein said first entity (proximately or otherwise) performs said method by invoking at least said first, second, and third circuitry 130.
55. The method of ANY one of the above method clauses wherein said second entity (directly or otherwise) performs said method by invoking at least said first, second, and third circuitry 130.
56. A meta-transaction-enabling content transfer system 100, 200, 300 comprising:
first transistor-based circuitry (e.g., one or more registration modules 128) configured to implement first (instance of) meta-transaction-enabling code 173 in a domain 290A associated with the first entity associated with a first entity wherein the first meta-transaction-enabling code 173 comprises one or more meta-transaction-enabling smart contracts 273;
second transistor-based circuitry (e.g., one or more response modules 123) configured to cause the first meta-transaction-enabling code 173 in the domain 290A associated with the first entity to extract from a first meta-transaction 386 a (sender address 251 or other) sender identifier 252 in association 162 with a first transfer 166 of first content 176 from a second entity after the first meta-transaction 386 was sent to the domain 290A associated with the first entity by the one or more relay modules 125 wherein the first transfer 166 of the first content 176 from the second entity is a first component 365 of the first meta-transaction 386 and wherein the transfer 166 of the first meta-transaction 386 to the domain 290A associated with the first entity is expedited by the one or more relay modules 125 expending a first (non-zero amount of a) digital resource 266; and
third transistor-based circuitry (e.g., one or more relay modules 125) configured to cause the first content 176 to become available to the first entity (within or otherwise) via the domain 290A associated with the first entity partly based on the sender identifier 252 associated with the first transfer 166 of the first content 176 having been extracted from (a digital expression of) the first meta-transaction 386 and partly based on a first cryptographic key 256 at least some of which was received (directly or otherwise) from the second entity.
57. The system of Clause 56, wherein all of the transistor-based circuitry 130 is implemented on a single application-specific integrated circuit (ASIC).
58. The system of Clause 56, wherein the transistor-based circuitry 130 is distributed across two or more mutually remote facilities spanning more than 100 kilometers.

With respect to the numbered claims expressed below, those skilled in the art will appreciate that recited operations therein may generally be performed in any order. Also, although various operational flows are presented in sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. (canceled)

2. The method of claim 18 comprising:
invoking fourth transistor-based circuitry configured to cause an emission that implements said first meta-transaction to a Layer-2 support platform partly based on no irregularities having been detected by said first evaluation function and partly based on a prioritization by which a non-zero quantity of utility tokens are expended wherein third meta-transaction-enabling code permits said first meta-transaction to be executed only after a second participant-defined meta-transaction-execution-prerequisite condition is verified that includes a second evaluation function confirming that said first meta-transaction includes a transfer of a particular second content type to a digital domain associated with said second entity and wherein fourth meta-transaction-enabling code permits said first meta-transaction to be executed only after a third participant-defined meta-transaction-execution-prerequisite condition is verified that includes a third evaluation function confirming that said first meta-transaction includes a transfer of a particular third content type to a digital domain of a third entity.

3. The method of claim 18 comprising:
invoking fourth transistor-based circuitry configured to cause an emission that implements said first meta-transaction to a side-chain support platform partly based on no irregularities having been detected by said first evaluation function and partly based on a prioritization by which a non-zero quantity of Layer-2 utility tokens are expended wherein third meta-transaction-enabling code permits said first meta-transaction to be executed only after a second participant-defined meta-transaction-execution-prerequisite condition is verified that includes a second evaluation function confirming that said first meta-transaction includes a transfer of a particular second content type to a digital domain associated with said second entity and wherein fourth meta-transaction-enabling code permits said first meta-transaction to be executed only after a third participant-defined meta-transaction-execution-prerequisite condition is verified that includes a third evaluation function confirming that said first meta-transaction includes a transfer of a particular third content type to a digital domain of a third entity.

4. The method of claim 18 comprising:
invoking other transistor-based circuitry configured to cause an emission that implements said first meta-transaction to a public blockchain platform partly based on no irregularities having been detected by said first evaluation function and partly based on a prioritization by which a non-zero resource quantity is expended wherein third meta-transaction-enabling code permits said first meta-transaction to be executed only after a second participant-defined meta-transaction-execution-prerequisite condition is verified that includes a second evaluation function confirming that said first meta-transaction includes a transfer of a particular second content type to a digital domain associated with said second entity and wherein fourth meta-transaction-enabling code permits said first meta-transaction to be executed only after a third participant-defined meta-transaction-execution-prerequisite condition is verified that includes a third evaluation function confirming that said first meta-transaction includes a transfer of a particular third content type to a digital domain of a third entity.

5. A meta-transaction-enabling content transfer method comprising:
implementing, by first transistor-based circuitry, one or more meta-transaction-enabling smart contracts in a digital domain associated with a first entity wherein said one or more meta-transaction-enabling smart contracts comprises first meta-transaction-enabling code;
causing, by second transistor-based circuitry, said one or more meta-transaction-enabling smart contracts to extract from a first meta-transaction a sender identifier associated with first content from a second entity;
causing, by third transistor-based circuitry, said first content to become available to said first entity via said digital domain associated with said first entity partly based on said sender identifier associated with said first content having been extracted from said first meta-transaction and partly based on a first cryptographic key from said second entity;
implementing, by fourth transistor-based circuitry, said first meta-transaction partly based on no irregularities having been detected and partly based on a first non-zero expenditure of Layer-2 utility tokens.

6. The method of claim 5
implements wherein said first meta-transaction is implemented via a Polygon support platform
wherein said pattern recognition protocol is applied by which a first participant-defined meta-transaction-execution-prerequisite condition is verified that includes a first evaluation function confirming that said first meta-transaction indicates a recipient-approved first content type being transferred to said digital domain associated with said first entity;
wherein second meta-transaction-enabling code permits said first meta-transaction to be executed only after a pattern recognition protocol is applied by which a first meta-transaction-execution-prerequisite condition is verified;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity; and
wherein said first meta-transaction provides that said particular second content type is revealed to said first entity when and not before said first meta-transaction is executed.

7. The method of claim 5
wherein said first cryptographic key was received off-chain from said second entity at a first permit function that thereby enabled a first transfer from said second entity to said digital domain associated with said first entity;
wherein said pattern recognition protocol is applied by which a first participant-defined meta-transaction-execution-prerequisite condition is verified that includes said first evaluation function confirming that said first meta-transaction indicates said recipient-approved first content type being transferred to said digital domain associated with said first entity;
wherein second meta-transaction-enabling code permits said first meta-transaction to be executed only after a pattern recognition protocol is applied by which a first meta-transaction-execution-prerequisite condition is verified that includes said first evaluation function confirming that said first meta-transaction indicates said recipient-approved first content type being transferred to said digital domain associated with said first entity;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein said second meta-transaction-execution-prerequisite condition was received from said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity;
wherein said third meta-transaction-execution-prerequisite condition was received from said third entity;
wherein fifth meta-transaction-enabling code permits said first meta-transaction to be executed only after a fourth meta-transaction-execution-prerequisite condition is verified that includes a fourth evaluation function confirming that said first meta-transaction includes a transfer of a particular fourth content type to a digital domain associated with a fourth entity;
wherein said fourth meta-transaction-execution-prerequisite condition was received from said fourth entity;
wherein said first meta-transaction provides that said transfer of said particular fourth content type to said digital domain associated with said fourth entity is to be sent from said digital domain associated with said first entity; and
wherein said first meta-transaction provides that at least an identifier of said third entity is revealed to said first entity when and not before said first meta-transaction is executed.

8. The method of claim 5
wherein said first cryptographic key was received off-chain from said second entity at a first permit function that thereby enabled a first transfer from said second entity to said digital domain associated with said first entity;
wherein second meta-transaction-enabling code permits said first meta-transaction to be executed only after a pattern recognition protocol is applied by which a first meta-transaction-execution-prerequisite condition is verified;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity.

9. The method of claim 5
wherein all of said invoking all of said transistor-based circuitry was performed by said first entity having provided an invocation that enabled a first transfer from said second entity on a single mobile device;
wherein second meta-transaction-enabling code permits said first meta-transaction to be executed only after a pattern recognition protocol is applied by which a first meta-transaction-execution-prerequisite condition is verified that includes said first evaluation function confirming that said first meta-transaction indicates said recipient-approved first content type being transferred to said digital domain associated with said first entity;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity.

10. The method of claim 5
wherein said first cryptographic key was received off-chain from said second entity at a first permit function that thereby enabled a first transfer from said second entity to said digital domain associated with said first entity;
wherein all of said invoking all of said transistor-based circuitry was performed by said first entity having provided an invocation that enabled said first transfer from said second entity on a single mobile device;
wherein second meta-transaction-enabling code permits said first meta-transaction to be executed only after a pattern recognition protocol is applied by which a first meta-transaction-execution-prerequisite condition is verified;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity; and
wherein said third meta-transaction-execution-prerequisite condition was received from said third entity.

11. (canceled)

12. The method of claim 5
wherein a pattern recognition protocol is applied by which a first participant-defined meta-transaction-execution-prerequisite condition is verified that includes said first evaluation function confirming that said first meta-transaction indicates said recipient-approved first content type being transferred to said digital domain associated with said first entity;
wherein all of said transistor-based circuitry was invoked by said first entity having provided an invocation that enabled a first transfer from said second entity on a single mobile device;
wherein second meta-transaction-enabling code permits said first meta-transaction to be executed only after a pattern recognition protocol is applied by which a first meta-transaction-execution-prerequisite condition is verified;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity;
wherein said third meta-transaction-execution-prerequisite condition was received from said third entity; and
wherein said first meta-transaction provides that said particular second content type is revealed to said first entity when and not before said first meta-transaction is executed.

13. The method of claim 5
wherein a pattern recognition protocol is applied by which a first participant-defined meta-transaction-execution-prerequisite condition is verified that includes said first evaluation function confirming that said first meta-transaction indicates said recipient-approved first content type being transferred to said digital domain associated with said first entity;
wherein second meta-transaction-enabling code permits said first meta-transaction to be executed only after a pattern recognition protocol is applied by which a first meta-transaction-execution-prerequisite condition is verified that includes said first evaluation function confirming that said first meta-transaction indicates said recipient-approved first content type being transferred to said digital domain associated with said first entity;
wherein third meta-transaction-enabling code permits said first meta-transaction to be executed only after a second meta-transaction-execution-prerequisite condition is verified that includes a second evaluation function confirming that said first meta-transaction includes a transfer of a particular second content type to a digital domain associated with said second entity;
wherein said second meta-transaction-execution-prerequisite condition was received from said second entity;
wherein fourth meta-transaction-enabling code permits said first meta-transaction to be executed only after a third meta-transaction-execution-prerequisite condition is verified that includes a third evaluation function confirming that said first meta-transaction includes a transfer of a particular third content type to a digital domain associated with a third entity;
wherein said third meta-transaction-execution-prerequisite condition was received from said third entity;
wherein fifth meta-transaction-enabling code permits said first meta-transaction to be executed only after a fourth meta-transaction-execution-prerequisite condition is verified that includes a fourth evaluation function confirming that said first meta-transaction includes a transfer of a particular fourth content type to a digital domain associated with a fourth entity; and
wherein said fourth meta-transaction-execution-prerequisite condition was received from said fourth entity.

14. A meta-transaction-enabling content transfer computer program product comprising:
one or more tangible non-transitory storage media; and
machine instructions borne on said one or more tangible, non-transitory storage media which, when running on one or more computer systems, cause said one or more computer systems to perform a method that comprises:
implementing one or more meta-transaction-enabling smart contracts in a digital domain associated with a first entity wherein said one or more meta-transaction-enabling smart contracts comprises first meta-transaction-enabling code;
causing said one or more meta-transaction-enabling smart contracts in said digital domain to extract from said first meta-transaction a sender identifier associated with first content from a second entity;
causing said first content to become available to said first entity via said domain associated with said first entity partly based on said sender identifier associated with said first content having been extracted from said first meta-transaction and partly based on a first cryptographic key from said second entity; and
implementing said first meta-transaction partly based on no irregularities having been detected and partly based on a first non-zero expenditure of Layer-2 utility tokens.

15. (canceled)

16. The method of claim 5
wherein said transfer of said first meta-transaction to said digital domain associated with said first entity is expedited by said one or more relay modules expending a first digital resource comprising a non-zero amount of a utility token; and
wherein second meta-transaction-enabling code permits said first meta-transaction to be executed only after a pattern recognition protocol is applied by which a first meta-transaction-execution-prerequisite condition is verified that includes a first evaluation function confirming that said first meta-transaction indicates a recipient-approved first content type being transferred to said digital domain associated with said first entity.

17. The method of claim 5
wherein said one or more meta-transaction-enabling smart contracts extracts said sender identifier from said first meta-transaction after said first meta-transaction was sent to said digital domain associated with said first entity by said one or more relay modules;
wherein said transfer of said first meta-transaction to said digital domain associated with said first entity is expedited by said one or more relay modules expending a first digital resource comprising a non-zero amount of a utility token; and
wherein second meta-transaction-enabling code permits said first meta-transaction to be executed only after a pattern recognition protocol is applied by which a first meta-transaction-execution-prerequisite condition is verified that includes a first evaluation function confirming that said first meta-transaction indicates a recipient-approved first content type being transferred to said digital domain associated with said first entity.

18. A meta-transaction-enabling content transfer method comprising:
implementing, by first transistor-based circuitry, one or more meta-transaction-enabling smart contracts in a digital domain associated with a first entity wherein said one or more meta-transaction-enabling smart contracts comprises first meta-transaction-enabling code;
causing, by second transistor-based circuitry, said one or more meta-transaction-enabling smart contracts to extract from a first meta-transaction a sender identifier associated with first content from a second entity;
causing, by third transistor-based circuitry, said first content to become available to said first entity via said digital domain associated with said first entity partly based on said sender identifier associated with said first content having been extracted from said first meta-transaction and partly based on a first cryptographic key from said second entity; and
implementing, by fourth transistor-based circuitry, said first meta-transaction partly based on no irregularities having been detected and partly based on a first non-zero expenditure of Layer-2 utility tokens
wherein said one or more meta-transaction-enabling smart contracts extracts said sender identifier from said first meta-transaction after said first meta-transaction was sent to said digital domain associated with said first entity by said one or more relay modules; wherein a first transfer of said first content from said second entity is a component of said first meta-transaction; wherein said transfer of said first meta-transaction to said digital domain associated with said first entity is expedited by said one or more relay modules expending a first digital resource comprising a non-zero amount of a utility token; and wherein second meta-transaction-enabling code permits said first meta-transaction to be executed only after a pattern recognition protocol is applied by which a first meta-transaction-execution-prerequisite condition is verified that includes a first evaluation function confirming that said first meta-transaction indicates a recipient-approved first content type being transferred to said digital domain associated with said first entity.

19. The method of claim 18 comprising:
transferring, by one or more relay modules, said first cryptographic key from said second entity, wherein said sender identifier identifies said second entity.

20. The method of claim 18 comprising:
transferring, by one or more relay modules, said first cryptographic key from said second entity, wherein said sender identifier identifies said second entity; and
transferring, by said one or more relay modules, said first meta-transaction from said second entity, wherein said sender identifier identifies said second entity.

21. The method of claim 18 comprising:
expediting, by a Layer-2 support platform, said first transfer of said first content from said second entity by implementing said first non-zero expenditure of Layer-2 utility tokens.
